(19) United States
(12) Patent Application Publication
(10) Pub. No.: US 2021/0309255 A1
(43) Pub. Date: Oct. 7, 2021

(54) METHOD AND APPARATUS FOR OPERATING A MOTOR VEHICLE IN AN AUTOMATED DRIVING MODE

(71) Applicant: Robert Bosch GmbH, Stuttgart (DE)

(72) Inventor: Ruben Roesner, Leimersheim (DE)

(21) Appl. No.: 17/215,890

(22) Filed: Mar. 29, 2021

(30) Foreign Application Priority Data
Apr. 3, 2020 (DE) 102020204353.1

(51) Int. Cl. B60W 60/00; B60W 50/14

(52) U.S. Cl. CPC B60W 60/0015; B60W 2554/00; B60W 50/14

(57) ABSTRACT

A method for operating a motor vehicle in an automated driving mode by way of an assistance function for automated driving in consideration of a performance capability of the assistance function, the performance capability being reconciled with a performance demand in order to perform the assistance function. In the method, a performance demand for an upcoming driving situation is ascertained as a performance demand. Also provided according to the present invention is an apparatus that is configured to execute the method.

### CROSS REFERENCE

The present application claims the benefit under 35 U.S.C. § 119 of German Patent Application No. DE 102020204353.1 filed on Apr. 3, 2020, which is expressly incorporated herein by reference in its entirety.

### FIELD

The present invention relates to a method for operating a motor vehicle in an automated driving mode by way of an assistance function for automated driving in consideration of a performance capability of the assistance function, the performance capability being reconciled with a performance demand in order to perform the assistance function. In the method, a performance demand for an upcoming driving situation is ascertained as a performance demand. Also provided according to the present invention is an apparatus that is configured to perform the method.

### BACKGROUND INFORMATION

A motivating force behind present-day development in motor vehicles is the sector of automated driving functions, in which a “feature” takes on the task of driving a motor vehicle. At a low automation level (e.g., SAE≤L2) the driver has complete responsibility for the vehicle driving task (mind-on and hands-on). The term “advanced driver assistance system” (ADAS) is also used. At a higher automation level (e.g., SAE>L2, i.e. L2+ to L4/5) the system gradually takes on more and more responsibility, and the human driver can be taken out of the driving task via the stages of hands-off, mind-off, and driverless. The term “automated driving” (AD) can also be used. According to SAE J3016, the term “operational design domain” (ODD) describes the operating conditions for which an assistance system for automated driving has been developed and can therefore be operated reliably. The ODD is therefore the design domain of an ADAS/AD feature in terms of the operating conditions and the environment which must exist in order for the feature to be able, and permitted, to actively take on driving tasks. A departure of the ODD from an ADAS/AD feature therefore results in unacceptable risks to occupants and traffic participants.

### SUMMARY

The method according to the present invention, conversely, advantageously makes possible prompt recognition of a departure from the operational design domain of an automated driving function. Prompt recognition makes it possible, for example, to initiate measures to prevent an actual departure. Thus not only is safety enhanced, but the utility and availability of an automated driving function are also expanded.

This is made possible according to the invention by the features in accordance with the present invention. Further embodiments of the present invention are disclosed herein.

In the method according to the present invention for operating a motor vehicle in an automated driving mode by way of an assistance function for automated driving in consideration of a performance capability of the assistance function, the performance capability being reconciled with a performance demand in order to perform the assistance function, a performance demand for an upcoming driving situation is ascertained as a performance demand.

This can be understood to mean that an automated driving maneuver that is suitable for the upcoming driving situation is planned. A determination is then made as to the performance demand that would be necessary for execution of that driving maneuver. That performance demand is reconciled with the performance capability of the automated driving function which is available in the system. It is thereby advantageously possible to ascertain, even before the driving maneuver is initiated, whether the driving maneuver can in fact be (completely) executed. If that is not the case, for example if the performance demand for the driving situation exceeds the performance capability of the system, corresponding measures (including preventive ones) can be initiated. An increase in safety is thereby made possible. In addition, the initiation of preventive measures advantageously makes it possible to avoid an actual departure from the performance capability. The advantageous result thereof is an increase in operational capability thanks to maintenance of the automated driving function.

The term “upcoming driving situation” can be understood as a “driving scenario.” The term “performance demand for an upcoming driving situation” can correspondingly be understood as a “performance demand for a driving scenario.” A “driving scenario” is to be understood as the possible execution of a defined driving maneuver in a described driving environment. This is intended in particular to encompass the execution of a planned automated driving maneuver in the currently existing driving environment of the motor vehicle.

The term “performance demand for an upcoming driving situation” is to be understood in detail to mean that the vehicle is currently in a defined and/or ascertainable driving environment, and a next-in-sequence driving maneuver is being evaluated. The respective driving maneuver is therefore to be understood in particular as the next planned one. A change in the driving environment can, however, occur in the course of or as a result of the execution of the driving maneuver, and that change is of course advantageously taken into consideration in that context. The “performance demand” for the upcoming driving situation is therefore understood in this sense as the performance demand that is necessary for the driving maneuver for (further) execution of the automated driving function in consideration of the existing environment of the motor vehicle. The term “upcoming driving situation” is therefore understood to mean the planned driving maneuver of the vehicle in the existing environment of the vehicle.

The performance demand can be ascertained in the motor vehicle itself. For example, the performance demand can be ascertained on the basis of data of the environmental sensor system (e.g. video sensor system). These data can be converted for that purpose into graph-based data formats, for instance into labeled property graph (LPG) data. Graph-based data structures, for instance ontologies, can also be created from the (converted) data in order to describe the performance demand.

The performance capability can be stored in the vehicle itself. For example, the performance capability can be described in the form of so-called “feature ODDS.” The LPG data format can also be used to describe the performance capability.

In an advantageous embodiment of the present invention, in the method, a reaction measure is initiated when a determination is made that the performance demand for the upcoming driving situation lies outside the performance capability of the assistance function.

This is to be understood to mean that defined measures are executed if the performance demand ascertained for execution of a driving maneuver exceeds the available performance capability of the system. These measures can be preventive or reactive. A preventive measure could advantageously have the objective of avoiding an actual departure from the performance capability, for example by modifying the driving maneuver. A reactive measure could have the objective, in the context of an actual departure from the performance capability, of continuing to ensure, or of reestablishing, a sufficient level of traffic safety and system safety.

In a possible embodiment, the method is characterized in that
an evasive measure, in particular a modification of the automated driving maneuver, is executed in order to avoid a departure from the performance capability; and/or
a safety measure, in particular a degradation of the assistance function for automated driving and/or initiation of a safe stop driving maneuver and/or output of a warning, is executed in order to enable sufficient traffic safety in the context of a departure from the performance capability,
   as a reaction measure.

This is to be understood to mean that, for example, a modification of the driving maneuver toward a lower performance demand can be carried out as a measure. It is also possible, of course, for a warning to the driver or a discontinuation of the automated driving function to occur correspondingly. Enhanced safety is thereby made possible. In addition, the initiation of preventive measures advantageously makes it possible to avoid an actual departure from the performance capability. This advantageously results in an increase in operability thanks to maintenance of the automated driving function. Alternatively or additionally, an addition of external resources could also be carried out as a measure for increasing the performance capability of the system.

In a preferred embodiment of the present invention, in the method, a probability is ascertained as to whether the performance demand will exceed the performance capability upon execution of the assistance function in the upcoming driving situation, it being assumed in particular that, upon an exceedance of a limit value for that probability, the performance demand lies outside the performance capability of the assistance function.

This is understood to mean that a probability of a possible departure from the performance capability upon further execution of the assistance function in the upcoming driving situation, in particular upon execution of the planned driving maneuver, is ascertained. Upon an exceedance of a defined limit value for a probable departure from the performance capability, it is assumed that the performance demand for the upcoming driving situation lies outside the performance capability. It is correspondingly assumed that ensured execution of the planned driving maneuver cannot occur.

In an alternative refinement, in the method, a graph-based data structure is used to describe the performance demand for the upcoming driving situation, and/or a graph-based data structure is used to describe the performance capability of the assistance function.

This is understood to mean that the performance capability is described by way of graph-based data structures. This is further understood to mean that the performance demand is described by way of graph-based data structures. Both ODD and vehicle data can correspondingly also be present or used in the graph-based data structures and/or databases. Labeled property graph (LPG) data, for example, can be utilized as a data format. Alternatively, any other technically suitable description format is of course also possible, in particular a resource description framework (RDF).

In an advantageous embodiment, in the method, an ontology with regard to the upcoming driving situation is created in order to ascertain the performance demand for the upcoming driving situation.

This is understood to mean that, for example, ontological data structures are created and used. The ontologies with regard to the performance demand are advantageously created based on ascertained data regarding the present driving situation.

In a possible embodiment, the method is characterized in that in order to ascertain the performance demand for the upcoming driving situation, the upcoming driving situation is described based on:
data ascertained by way of an ego vehicle sensor system; and/or
by way of external data conveyed to the vehicle.

This is understood to mean that relevant input variables and data regarding the current vehicle environment are ascertained by way of vehicle sensor systems, for example radar, video, GPS, sensors, ECU, actuators. Advantageously, structures (i.e., apparatuses) already present in the motor vehicle are used for this (if present).

In a preferred refinement of the present invention, in the method, at least one of the following steps is executed in order to ascertain the performance demand for the upcoming driving situation:
ascertainment of raw data;
preprocessing of raw data;
object classification;
transformation of available data into a graph-based data format, in particular transformation into a labeled property graph (LPG);
creation of connections, in particular creation of individual ontologies and/or overall ontologies;
storage of a data structure, in particular storage of an overall ontology.

This is understood to mean in particular that existing or ascertained input data, or raw data, or classified objects are transformed into a graph-based data format. A “graph-based data format” is understood, for example, as an LPG. In an alternative embodiment, the method is characterized in that defined input data are converted into graph-based data structures in order to describe the upcoming driving situation. “Graph-based data structures” are understood, for example, as ontologies.

In an advantageous refinement of the present invention, in the method, an ontology regarding possible utilization conditions of the assistance function is taken into consideration in order to describe the performance capability of the assistance function.

This is understood to mean that graph-based data structures are used not only with regard to the performance demand but also with regard to the performance capability. Ontologies are also taken into consideration in the description of the performance capability. Advantageously, ontologies regarding the performance capability can already be stored in the system. The system itself can therefore store a graph-based description of the operating conditions and operating possibilities, so that they do not need to be generated in the individual case but can instead be retrieved from a database. A database of this kind can also be located outside the motor vehicle.

In a possible embodiment of the present invention, in the method, a PEGASUS ontology, in particular a PEGASUS ontology supplemented with a human factor, is taken into account in order to describe the performance capability of the assistance function.

This is understood to mean that a PEGASUS ontology is utilized in order to ascertain the performance demand and/or the performance capability. In particular, a PEGASUS ontology that is supplemented with a human factor is used for this. A PEGASUS ontology supplemented in this fashion for describing, for example, the ODD can advantageously take into consideration the following aspects:
L1 Road level
L2 Traffic infrastructure
L3 Temporary influence on L1 and L2
L4 Movable objects including possible behavior thereof
L5 Environmental conditions
L6 Digital information
L7 Human driver of the ego vehicle
Relative and absolute position with respect to other objects
Driving maneuvers

In a preferred embodiment of the present invention, the method encompasses a bidirectional exchange of data with an external resource, in particular with an edge server and/or cloud server, in particular, data for ascertaining the performance demand and/or data for describing the performance capability of the assistance function being exchanged with external resources, and/or in particular, the performance demand for the upcoming driving situation being reconciled with the performance capability of the assistance function by way of the external resource.

This is understood to mean that not only resources that are vehicle-internal, for example a control device installed in the motor vehicle, can be taken into consideration and used. It is instead also possible to use (as necessary) resources that are vehicle-external. Advantageously, cloud services and cloud technologies are used for this. For example, so-called performant data analytic algorithms and/or big data graph analytics can be used in this context, for example in order to ascertain the performance demand or to reconcile the performance demand with the performance capability.

This method can be implemented, for example, in software or hardware or in a mixed form of software and hardware, for example in a control device.

The approach presented here furthermore creates an apparatus that is embodied to carry out, control, or implement the steps of a variant of a method presented here in corresponding devices. This variant embodiment of the invention in the form of an apparatus also allows the object on which the invention is based to be achieved quickly and efficiently.

An “apparatus” can be understood in the present case as an electrical device that processes sensor signals and outputs control signals and/or data signals as a function thereof. The apparatus can have an interface that can be embodied on a hardware and/or software basis. In a hardware-based embodiment the interfaces can be, for example, part of a “system ASIC” that contains a wide variety of functions of the apparatus. It is also possible, however, for the interfaces to be independent integrated circuits or to be made up at least in part of discrete components. In a software-based embodiment the interfaces can be software modules that are present, for example, on a microcontroller alongside other software modules. An apparatus can therefore include, for example: a central control device, in particular a central operational design domain computing unit; a control device for a camera; a camera system; other sensors for detecting the vehicle environment; an apparatus for exchanging data with a vehicle-external resource, etc.

Also advantageous is a computer program product or computer program having program code that can be stored on a machine-readable carrier or memory medium such as a semiconductor memory, a hard disk drive, or an optical memory and is used to carry out, implement, and/or control the steps of the method in accordance with one of the embodiments described above, in particular when the program product or program is executed on a computer or an apparatus.

It is to be noted that in the description, individually described features can be combined with one another in any technically useful manner and can indicate further embodiments of the present invention. Further features and useful aspects of the present invention are evident from the description of exemplifying embodiments with reference to the Figures.

### BRIEF DESCRIPTION OF THE DRAWINGS

FIG. 1 shows a schematic embedding of the central control apparatus (central operational design domain computing unit), in accordance with an example embodiment of the present invention.

FIG. 2 shows method steps of an exemplifying embodiment, in accordance with the present invention.

FIG. 3 shows method steps for generating the ODD data, in accordance with an example embodiment of the present invention.

FIG. 4 schematically depicts the ontology-based comparison between performance capability and performance demand, in accordance with an example embodiment of the present invention.

### DETAILED DESCRIPTION OF EXAMPLE EMBODIMENTS

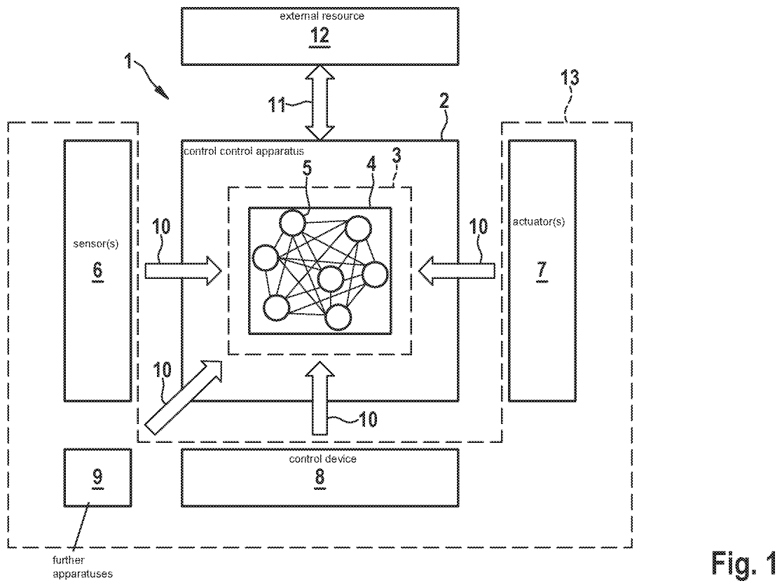

FIG. 1 shows a schematic embedding of a central control apparatus (central operational design domain computing unit, cODDU). Central control apparatus 2 is integrated into a motor vehicle 1. Central control apparatus 2 can of course also be part of another control device. Motor vehicle 1 can be operated in an automated driving function (“feature”). The automated driving function can be operated only within defined limits, i.e. within performance capability 3 of the driving function (within the “feature capabilities”). The “operational design domains” (ODD) describe the situations and conditions within which the driving function can be operated. FIG. 1 schematically depicts performance capability 3 of the driving function. Also schematically depicted in FIG. 1 is a description 4 of the performance capability of the driving function. This description 4 is made, for example, in a graph structure. Depicted by way of example for these are several nodes 5 of a “labeled property graph” (LPG), including connections thereof. The ODDs of the automation features of the vehicle are therefore stored as an ontology in a labeled property graph. The ODD of the features is consequently defined in terms of the feature capabilities, and stored on the cODDU as an ontology. The result is to specify the ODD in which the vehicle having an active AD/ADAS feature is capable of operating or permitted to operate; this in turn serves as an input as to whether the feature can safely execute the maneuver in a given context.

FIG. 1 furthermore schematically shows performance demand 13 for the upcoming driving situation of the motor vehicle. The current vehicle environment is detected by the vehicle by way of various apparatuses. These can include: sensors 6, actuators 7, control device 8, and further apparatuses 9 for acquiring relevant data. These data are conveyed to central control apparatus 2 by way of a unidirectional information flow 10. The relevant raw or processed data of the data sources (sensors, ECUs, actuators, cloud) are transformed into LPG data either close to the source or upon entry into the cODDU, where they are stored e.g. as a “live LPG” ontology.

Central control apparatus 2 can make use of an external resource 12 in order to assist the evaluation. An external database or an external calculation apparatus can serve, for example, as an external resource 12. Data exchange between central control apparatus 2 and an external resource occurs, for example, by way of a bidirectional information flow 11. In other words, a bidirectional connection exists to external resources, such as an edge or cloud server, with which further data relevant to the ODD “departure detection function” can be exchanged. The cODDU thus calculates, for each point in time, a valid “live LPG ontology” that is reconciled with the stored feature ODD. Also existing for each ADAS/AD feature is a “feature capability list,” which is stored in the cODDU and with which the current feature capabilities are calculated based on a requisite maneuver and a relative or absolute position with respect to other objects. It is also possible to warn predictively of a departure from the ODD, and to initiate preventive measures.

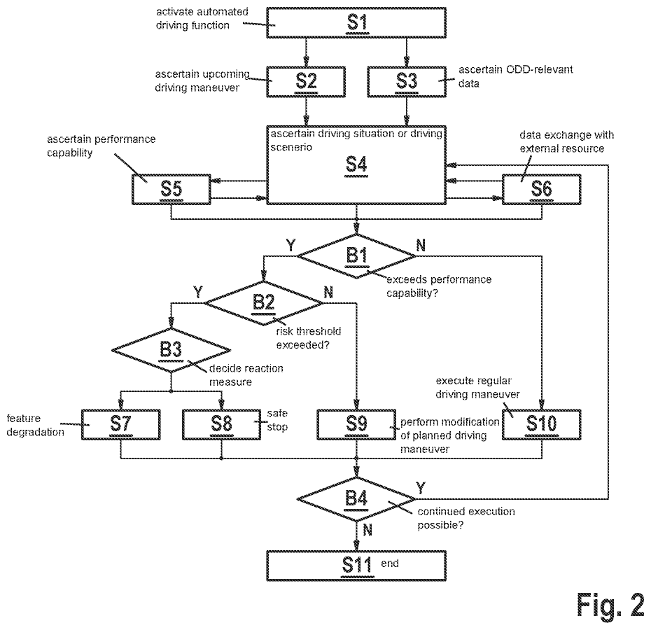

FIG. 2 depicts the method steps of an embodiment of the present invention. In a first step S1 the method is started, for example by activating the automated driving function. In a step S2 the upcoming driving maneuver is ascertained, i.e., the driving maneuver that is to be accomplished in consideration of the upcoming driving situation in order to execute or continue executing the automated driving function. In a step S3, ODD-relevant data continue to be ascertained, i.e., data that are required in order to ascertain the driving situation or the suitable driving scenario and/or to ascertain the performance demand therefor. In a step S4, the driving situation or driving scenario is ascertained. The performance demand therefor is also ascertained in this step. Corresponding uncertainties can of course also be taken into account in this context. In a step S5, the performance capability of the assistance function is ascertained. This can involve, for example, accessing data stored in the vehicle. In a step S6, a data exchange with an external resource occurs. A vehicle-external database or computing capacity, for example an edge computer or cloud computer, can serve, for example, as an external resource.

A step B1 checks whether the ascertained performance demand for an upcoming driving situation or a specific driving maneuver exceeds the performance capability of the assistance function of the ADAS/AD feature. Probabilities can, of course, also be taken as a basis here. The step checks in particular whether a defined potential threshold is exceeded. If not (N branch), in a step S10 the regular driving maneuver is executed, i.e. the automated driving maneuver ascertained as suitable for the upcoming driving situation is carried out.

If the potential threshold is exceeded, however (Y branch), a further step B2 can check, for example, whether a risk threshold has also been exceeded. If the risk threshold has not yet been exceeded, for example (N branch), in a step S9, for example, a modification of the planned driving maneuver can be performed or at least analyzed. If the risk threshold has also been exceeded, however (Y branch), in a next step B3, for example, a decision can be made regarding a reaction measure. In a subsequent step S7, for example, a feature degradation, in which specific automated driving functions are discontinued, is possible. Alternatively or additionally, in a step S8 a “safe stop” driving maneuver can be performed, by way of which the vehicle is automatically brought into a safe state. A safe stop driving maneuver can encompass up to several kilometers. A subsequent step B4 checks whether continued execution of the automatic driving function is possible. If this is not the case (N branch), the method is ended with step S11. If it is the case, however (Y branch), the performance demand for the next driving situation can be ascertained and analyzed, for example, with step S4.

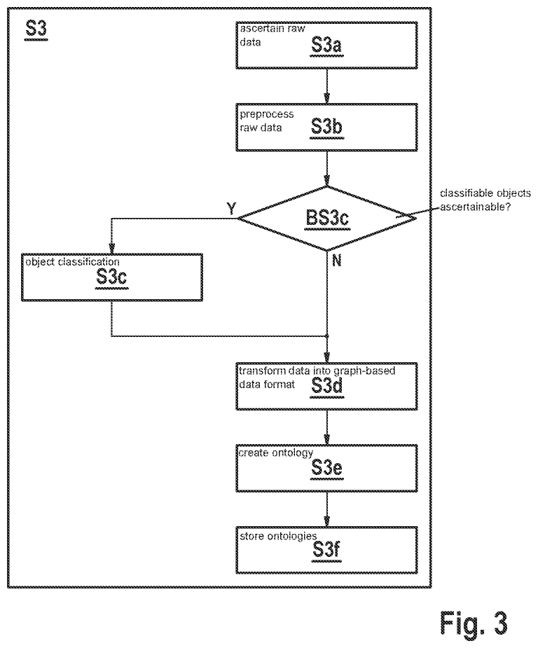

FIG. 3 depicts the method steps for generating the ODD data. This is therefore a possible technical embodiment of the previously described step S3 with regard to ascertaining the performance demand for an upcoming driving situation. For this, in a first sub-step S3a raw data are ascertained. This can be accomplished, for example, by way of a video camera. In a further sub-step 3b a preprocessing of the raw data occurs. A next step BS3c checks whether classifiable objects are ascertainable in the data. If that is the case (Y branch), object classification follows in a sub-step S3c. If that is not the case, however (N branch), no classification is performed. In a subsequent step S3d the data are transformed into a graph-based data format, for example into labeled property graph data. In a further sub-step S3e an ontology is created, in which context individual ontologies, as well as overall ontologies in consideration of linkages, can be prepared. In a concluding sub-step S3f the ontologies are stored.

In other words, the relevant input ODD data can be derived, for example, from all possible data-generating elements, for example a camera, radar, wheel rotation speed sensor, rack position of steering system, GNSS, acceleration sensor, inverter, battery management system, belt buckle, etc. Regardless of the type of raw-data preparation (e.g. close to source via ASIC versus zone or centralized control device), the raw data are first prepared and then, depending on whether or not they are classified, transformed into LPG data. In the case of a camera system that classifies an object with 75% probability as a bicycle, for example, an LPG node having the type and label “bicycle, probability=75%,” a time stamp, and other attributes (e.g. X-Y-Z position in the trajectory, ID, height, width, etc.) is constituted. All these input ODD data will constitute the corresponding node, and an ontology will be created and stored for each time stamp. The consequence is to generate and store a “live ODD” ontology with which progress of the vehicle and of the context can also be comprehended.

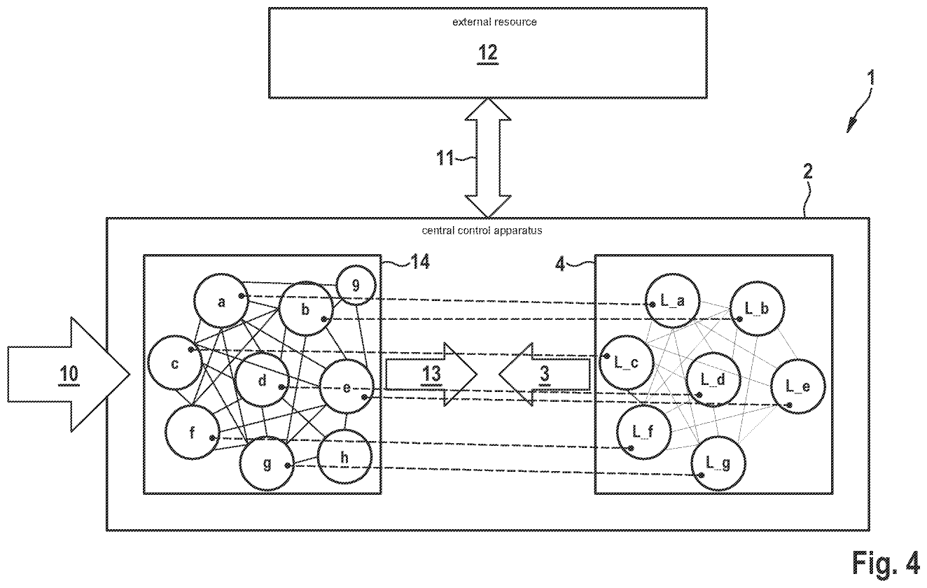

FIG. 4 schematically depicts the ontology-based comparison between performance capability and performance demand. FIG. 4 illustrates in particular the interaction of performance capability 3 of the driving function and performance demand 13 for the upcoming driving situation. As a supplement to FIG. 1, FIG. 4 also shows a description 14 of the performance demand for the driving situation in a graph structure. As has already been described with reference to FIG. 3, the data conveyed to the central control device are, for example, transformed into LPG data and corresponding ontologies for the performance demand are created. An ontology-based reconciliation of the performance capability with the performance demand can be made. In other words, firstly the relevant ODD data are processed in the cODDU, and a “situation/scenario demand and complexity” is calculated. The “demand” is a function of the incoming relevant input ODD data. This can also be understood as a degree of complexity of the situation and the scenario in which the vehicle is moving. The requirement and demand on the feature (automated driving function) is derived. In parallel therewith, feature capabilities are calculated from among the short-term executable maneuvers as well as future maneuvers to be expected, in consideration of the stored feature ODD. Lastly, a reconciliation is effected between demand and capability; with this, the situation is examined as to whether the feature can safely implement the desired and expected maneuver under the boundary conditions, or is located in the specified ODD, i.e. within the performance capability.

A further important element is represented by the external communication of the cODDU, with which maneuvers to be expected for the current position are furnished live, and further processed live data are exchanged. In addition, the live LPG ontologies of the vehicle can be sent to the server for validation, plausibilization, and big data analytics, with the result that constantly improved ODD departure models can be generated.

FIG. 4 further shows an ontology check between the live LPG ontology and the feature ODD. These live LPG ontology checks can thus also be exchanged with the cloud. If the demand exceeds the feature capabilities, either a degraded feature state can be initiated (as described with reference to FIG. 2), or a safe stop driving maneuver can be carried out.

What is claimed is:

1. A method for operating a motor vehicle in an automated driving mode using an assistance function for automated driving in consideration of a performance capability of the assistance function, the method comprising the following steps:
reconciling the performance capability with a performance demand to perform the assistance function;
ascertaining a performance demand for an upcoming driving situation as a performance demand.

2. The method as recited in claim 1, wherein a reaction measure is initiated when a determination is made that the performance demand for the upcoming driving situation lies outside the performance capability of the assistance function.

3. The method as recited in claim 1, wherein:
an evasive measure, including a modification of the automated driving maneuver, is executed in order to avoid a departure from the performance capability; and/or
a safety measure, including a degradation of the assistance function for automated driving and/or initiation of a safe stop driving maneuver and/or output of a warning, is executed in order to enable sufficient traffic safety in the context of a departure from the performance capability, as a reaction measure.

4. The method as recited in claim 1, wherein a probability is ascertained as to whether the performance demand will exceed the performance capability upon execution of the assistance function in the upcoming driving situation, it being assumed that, upon an exceedance of a limit value for that probability, the performance demand lies outside the performance capability of the assistance function.

5. The method as recited in claim 1, wherein a graph-based data structure is used to describe the performance demand for the upcoming driving situation, and/or a graph-based data structure is used to describe the performance capability of the assistance function.

6. The method as recited in claim 1, wherein an ontology with regard to the upcoming driving situation is created in order to ascertain the performance demand for the upcoming driving situation.

7. The method as recited in claim 1, wherein, to ascertain the performance demand for the upcoming driving situation, the upcoming driving situation is described based on:
data ascertained by way of an ego vehicle sensor system; and/or
external data conveyed to the vehicle.

8. The method as recited in claim 1, wherein at least one of the following steps is executed to ascertain the performance demand for the upcoming driving situation:
ascertainment of raw data;
preprocessing of raw data;
object classification;
transformation of available data into a graph-based data format, including transformation into a labeled property graph;
creation of connections, including creation of individual ontologies and/or overall ontologies;
storage of a data structure, including storage of an overall ontology.

9. The method as recited in claim 1, wherein an ontology regarding possible utilization conditions of the assistance function is taken into consideration in order to describe the performance capability of the assistance function.

10. The method as recited in claim 1, wherein a PEGASUS ontology, including a PEGASUS ontology supplemented with a human factor, is taken into account to describe the performance capability of the assistance function.

11. The method as recited in claim 1, wherein the method includes a bidirectional exchange of data with an external resource, including with an edge server and/or cloud server, wherein: (i) the data includes data for ascertaining the performance demand and/or data for describing the performance capability of the assistance function being exchanged with external resources, and/or (ii) the performance demand for the upcoming driving situation is reconciled with the performance capability of the assistance function by way of the external resource.

12. An apparatus configured to operate a motor vehicle in an automated driving mode using an assistance function for automated driving in consideration of a performance capability of the assistance function, the apparatus configured to:
reconcile the performance capability with a performance demand to perform the assistance function;
ascertain a performance demand for an upcoming driving situation as a performance demand.

13. A non-transitory machine-readable storage medium on which is stored a computer program for operating a motor vehicle in an automated driving mode using an assistance function for automated driving in consideration of a performance capability of the assistance function, the computer program, when executed by a computer, causing the computer to perform the following steps:
reconciling the performance capability with a performance demand to perform the assistance function;
ascertaining a performance demand for an upcoming driving situation as a performance demand.
